(19) United States
(12) Patent Application Publication
(10) Pub. No.: US 2023/0386711 A1
(43) Pub. Date: Nov. 30, 2023

(54) Rare earth magnet and manufacturing method thereof

(71) Applicant: Yantai Dongxing Magnetic Materials Inc., Yantai (CN)

(72) Inventors: Chuanshen WANG, Yantai (CN); Zhongjie PENG, Yantai (CN); Kunkun YANG, Yantai (CN); Zhanji DONG, Yantai (CN); Kaihong DING, Yantai (CN)

(21) Appl. No.: 18/201,747

(22) Filed: May 24, 2023

(30) Foreign Application Priority Data
May 31, 2022 (CN) 202210610371.6

(51) Int. Cl. H01F 1/057; H01F 41/02; C22C 38/00; C22C 38/16; C22C 38/14; C22C 38/10; C22C 38/06; B22F 9/04; B22F 9/02; B22F 3/16; B22F 3/26

(52) U.S. Cl. CPC H01F 1/057; H01F 41/0293; C22C 38/005; C22C 38/16; C22C 38/14; C22C 38/10; C22C 38/06; C22C 38/002; B22F 9/04; B22F 9/023; B22F 3/16; B22F 3/26; C22C 2202/02; B22F 2998/10; B22F 2999/00; B22F 2301/355; B22F 2202/05; B22F 2003/242

(57) ABSTRACT

The present disclosure provides a rare earth magnet and manufacturing method thereof, which belongs to the field of rare earth magnet technology. The diffusion source is coated on the NdFeB base material, which is diffused and aged to obtain NdFeB magnet. The diffusion source alloy is R_{α}M_{β}B_{γ}Fe_{100-α-β-γ}, wherein R refers to at least one of Nd and Pr, and M Refers to at least one of Al, Cu, Ga. The Br reduction range is lower than 0.03 T, and Hcj growth is more than 318 kA/m.

### TECHNICAL FIELD

The disclosure relates to the technical field of rare earth magnet, in particular to a rare earth magnet that can improve its own coercivity and its manufacturing method thereof.

### BACKGROUND

NdFeB sintered permanent magnets are widely used in high-tech fields such as electronic equipment, medical equipment, electric vehicles, household products, robots, etc. In the past few decades of development, NdFeB permanent magnets have been rapidly developed; especially diffusion technology can significantly reduce the consumption of heavy rare earths and has a large cost advantage.

Adding heavy rare earth elements Dy, Tb to the base metal in NdFeB sintered permanent magnet manufacturing process will make the heavy rare earth elements Dy, Tb into the grain in large quantities and consume a large number of heavy rare earth elements. This way leads to reduction of the residual magnetism and magnetic energy product of the magnet. Another method is grain boundary diffusion, which is a technology that the diffusion source is diffused into the magnet along the grain boundary to improve the coercivity of the magnet. This technology uses fewer heavy rare earths compared to other technologies, attaining the same coercivity of magnets. So it has attracted a lot of attention because of its low cost. However, with the current price of heavy rare earth Dy, Tb raw materials skyrocketing, the cost of grain boundary diffusion technology using pure Dy and Tb is still high. It is well known that the diffusion technology of heavy rare earth alloys can effectively reduce the content of heavy rare earth Dy and Tb to get low-cost magnets. Therefore, the development of diffusion technology of rare earth alloys is particularly important for the mass production of NdFeB magnets.

CN106298219B discloses the following: a) the diffusion source is RLᵤRHᵥFe_{100-u-v-w-z}B_{w}M_{z} rare earth alloy, the RL represents at least one element in Pr and Nd, RH represents at least one element in Dy, Tb, Ho, M represents at least one element in Co, Nb, Cu, Al, Ga, Zr, Ti, u, v, w, z is the weight percentage and 0≤u≤10, 3 5≤v≤7 0, 0.5≤w≤5, 0≤z≤5. b) Crush RLᵤRHᵥFe_{100-u-v-w-z}B_{w}M_{z} rare earth alloy to form alloy powders. c) The alloy powders are loaded into a rotary diffusion device with an R-T-B magnet for thermal diffusion, with temperature range of 750-950° C. and a time range of 4-72 h. d) Aging treatment. The diffusion source alloy, which is RLᵤRHᵥFe_{100-u-v-w-z}B_{w}M_{z} rare earth alloys, contains not only element of light rare earths, but also heavy rare earths. On one hand, when the B content in the diffusion source is too high, its melting point will be relatively high and it is not easy to diffuse into the magnet. On the other hand, the diffusion source contains heavy rare earths, the increase of coercivity have no obvious advantage compared to heavy rare earths after diffusion, which cannot achieve ideal performance.

CN113764147A discloses the following: Low melting point alloy (Dy,Tb)—Al—Cu, which contains element of heavy rare earth and (Pr,Ce)—Ga—Cu alloy which has high abundance are weighed separately and arc melted. They are then crushed by high-energy ball milling and planetary low-energy ball milling powder, which is mixed in proportion to make a paste solution. The pasted solution was uniformly applied to the surface of the NdFeB magnet, followed by primary and secondary tempering heat treatment assisted by N2 gas protection and low magnetic field. The purpose of using light rare earths in this technology is to improve the diffusion depth of heavy rare earths, and the role of light rare earths cannot improve coercivity, and heavy rare earths are also used.

CN113764147A discloses the following: the light rare earth alloy diffusion source was pasted to the surface of the light rare earth sintered NdFeB magnet for grain boundary diffusion treatment, and then tempered. The composition of the light rare earth alloy diffusion source is Pr_{A}Fe_{100-A}, wherein 10 wt %≤A≤90 wt %. The composition of the light rare earth sintered NdFeB magnet is as follows: R_{X}Fe_{y}M_{α}Ga_{b}Bₓ (I), R is selected from one or more of La, Ce, Nd and Pr, M₁ is selected from one or more of Cu, Al, Co and Zr, x is 28˜33 wt %, y is 60˜70 wt %, a is 0˜0.6 wt %, b is 0.1˜0.8 wt %, c is 0.9˜0.98 wt %. The diffusion source of this technology is PrAFe100−A, the iron content is too high, and too many ferromagnetic phases are formed after diffusion, although the Hcj of the magnet is improved, but the Br decline is large, which is not conducive to improving the overall performance.

Based on the above technical analysis, two problems are listed about grain boundary diffusion. On the one hand, heavy rare earths are not used. On the other hand, the performance of NdFeB magnets can not be greatly improved after the diffusion of light rare earths.

### SUMMARY

Object of the disclosure: In order to overcome the shortcomings in the prior art, the present disclosure provides a rare earth magnet and manufacturing method thereof.

Technical solution: In order to achieve the above object, a rare earth magnet of the present disclosure is a NdFeB magnet, and the NdFeB magnet comprises a main phase, a grain boundary phase and a rare earth-rich phase, wherein the grain boundary phase comprises a μ phase and a δ phase, the μ phase is R_{36.5}Fe_{63.5-x}Mₓ, 1≤x≤4; the δ phase is R_{32.5}Fe_{67.5-y}M_{y}, 2≤y≤20, wherein R refers to at least two elements selected from Nd, Pr, Ce and La, and M refers to at least two elements selected from Al, Cu and Ga; wherein the proportions are given in atomic percentages.

A method for preparing the rare earth magnet described comprising the following steps,
(S1) the preparation of a diffusion source: providing a diffusion source alloy of chemical formula R_{α}M_{β}B_{γ}Fe_{100-α-β-γ}, wherein 10≤α≤80, 15≤β≤90, 0.1≤γ≤3, R is at least one of Nd and Pr, and M is at least one of Al, Cu and Ga; the diffusion source alloy is treated by aging to form the diffusion source, the is treated by hydrogen absorption and dehydrogenation; wherein the proportions are given in mass percentage;
(S2) the preparation of NdFeB base material: preparing main alloy and auxiliary alloy of NdFeB magnet base material, the chemical formula of the mixed alloy of the main alloy and the auxiliary alloy is RₐM_{b}B_{c}Fe_{100-a-b-c}, wherein 27≤a≤0.33, 1≤b≤4, 0.8≤c≤1.2, R refers to one or more of Nd, Pr, Ce and La, and M refers to one or more of Al, Cu, Ga, Ti, Zr, Co, Mg, Zn, Nb, Mo and Sn, the remaining component is Fe; wherein the proportions are given in mass percentage
(S3) a diffusion source film layer is coated on the NdFeB base material, which is diffused and aged to obtain NdFeB magnet.

Preferably, step (S2) in which the NdFeB base material flakes are mixed with lubricants under hydrogen treatment, and grounded by airflow grinding to prepare mixed powders; then, the mixed powders are pressed, formed and sintered to obtain the NdFeB magnet base material.

Preferably, in step (S1), the diffusion source is powder form, and the preparation method of the diffusion source is atomized comminuting process, amorphous throwing belt milling process or ingot milling process.

Preferably, the hydrogen absorption temperature in step (S1) is 50-200° C.

Preferably, powder particle size of the airflow grinding is 2-5 μm.

Preferably, powder particle size of the diffusion source is 3-60 μm.

Preferably, the method of coating in step (S3) is one of magnetron sputtering coating, evaporation coating and silk screening coating.

Preferably, the temperature of sintering process for preparing the NdFeB magnet base material is 980-1060° C., sintering time is 6-15 h.

Preferably, the diffusion temperature in step (S3) is 800-910° C., the diffusion time is 6-30 h, and the first-stage aging temperature is 700-850° C., the first-level aging time is 2-10 h, the second-level aging temperature is 450-600° C., and the second-level aging time is 3-10 h.

Rare earth magnet and manufacturing method thereof of the present disclosure has at least the following technical effects:
(1) The diffusion source alloy R_{α}M_{β}B_{γ}Fe_{100-α-β-γ} has low content of high melting point B, and there are no high melting point heavy rare earth elements. The light rare earth element content is high, the diffusion coefficient is large. So the diffusion efficiency is high, and it is easy to diffuse into the magnet. This method can transport heavy rare earths into the magnet, forming more core shells and grain boundary structures, effectively increasing the coercivity of the magnet.
(2) The diffusion source alloy R_{α}M_{β}B_{y}Fe_{100-α-β-γ} contains B element, which can reduce the oxidation problem in the diffusion process, so as to increase the utilization efficiency of the element in the diffusion process.
(3) The diffusion source alloy R_{α}M_{β}B_{γ}Fe_{100-α-β-γ} contains B element and Fe element, which can form a new main phase by diffusing into the magnet, increasing the value residual magnetism (Br). The element of Fe can form p and δ phase with Al, Ga and Cu elements under the process of diffusion, so as to improve the coercivity of the magnet.
(4) The diffusion source alloy R_{α}M_{β}B_{y}Fe_{100-α-β-γ} contains B element and Fe element, and the total weight ratio of B and Fe can reach up to 20%, which can greatly reduce the price of diffusion source, thereby reducing production costs.
(5) The diffusion source can be prepared in large quantities, and the coating method can achieve nearly 100% utilization efficiency which can reduce production costs and improve the core competitiveness of NdFeB magnet products in the production process.

Compared with the prior art, the present disclosure realizes the cooperation between the light rare earth diffusion source and the corresponding component magnet, greatly improves the coercivity of the magnet, and reduces the problem of large Br decline in the process of light rare earth diffusion.

### DETAILED DESCRIPTION

The principles and features are described in the present disclosure, and the examples given are only used to explain the present disclosure and are not intended to limit the scope of the present disclosure.

General Concept There is provided a method of preparing NdFeB rare earth magnet, including the following steps:
(S1) Diffusion source production: diffusion source alloy composition was made up, which is as shown in Table 1; put into a vacuum melting furnace for melting, pouring to form an alloy sheet, and after cooling to 50° C., it was discharged; the average thickness of the alloy sheet is within the range of 0.25-1 mm, the content of C and O elements in the alloy sheet is ≤200 ppm, and the N content is ≤50 ppm. The alloy sheet was treated with hydrogen absorption and dehydrogenation, in which the hydrogen absorption temperature was 50-200° C. and the dehydrogenation temperature was 450-550° C.
(S2) NdFeB base alloy composition was made up, as shown in Table 2, which is put into vacuum melting furnace for melting, pouring to form a thin sheet, and after cooled to 50° C., it was discharged; the average thickness of the sheet is 0.25 mm, The C, O content is ≤200 ppm, the N content ≤50 ppm. The NdFeB base material flakes and lubricants are mixed for hydrogen treatment and then grinded to powders with size of 2-5 μm by argon gas. The NdFeB powder is put into an automatic press, pressed into blanks under a magnetic field, and packaged into blocks. The rough steak is put into the sintering furnace to get NdFeB base alloy, the sintering temperature is 980-1060° C., and the sintering time is 6-15 h. Finally, NdFeB base alloy is cut into strips.
(S3) The diffusion source prepared in step (S1) is prepared into slurry, and the diffusion source slurry is coated with a film on the NdFeB base metal, and then diffusion and aging treatment are carried out to obtain the NdFeB magnet. Diffusion and aging treatment are carried out to obtain NdFeB magnet, specific process conditions and the performance of NdFeB magnet is shown in Table 1.

In order to verify the present scheme, sixteen pairs of examples and comparative examples are designed and the difference between the proportion and the embodiment is as follows: The diffusion source of the comparative examples have no the components of B and Fe which are removed from the examples and placed in a vacuum melting furnace melting, pouring to form a thin sheet, and after cooling to 50° C., it was discharged; the thickness of the sheet is 0.25-1 mm, content of C and O≤200 ppm, content of N≤50 ppm. The composition and process conditions of the comparative examples are shown in Table 3.

Based on the above data, the light rare earth magnet is obtained by diffusion source alloy R_{α}M_{β}B_{γ}Fe_{100-α-β-γ}. Light rare earth magnets of all examples have ΔHcj of more than 318 kA/m significantly after diffusion. Residual magnetic reduction of light rare earth magnets of examples is significantly lower than that of comparative examples.

Therefore, the examples and comparative examples are specifically analyzed as follows:

Example 1 and Comparative example 1: The NdFeB magnet base alloy are diffused at the same composition and size, the same diffusion and aging temperature etc.

Example 1 shows Br=1.400 T, Hcj=1711.4 kA/m, containing μ phase and δ phase and Comparative example 1 shows Br=1.360 T, Hcj=1592 kA/m, only containing δ phase. Br (residual magnetism) and Hcj (coercivity) advantages of the Example is significantly improved compared to the Comparative Example.

Example 2 and Comparative example 2: The NdFeB magnet base alloy are diffused at the same composition and size, the same diffusion and aging temperature etc. Example 2 shows Br=1.400 T, Hcj=1830.8 kA/m, containing μ phase and δ phase and Comparative example 2 shows Br=1.350 T, Hcj=1671.6 kA/m, only containing δ phase. Br (residual magnetism) and Hcj (coercivity) advantages of the Example is significantly improved compared to the Comparative Example.

Example 3 and Comparative example 3: The NdFeB magnet base alloy are diffused at the same composition and size, the same diffusion and aging temperature etc. Example 3 shows Br=1.320 T, Hcj=1950.2 kA/m, containing μ phase and δ phase and Comparative example 3 shows Br=1.290 T, Hcj=1791.00 kA/m, only containing δ phase. Br (residual magnetism) and Hcj (coercivity) advantages of the Example is significantly improved compared to the Comparative Example.

Example 4 and Comparative example 4: The NdFeB magnet base alloy are diffused at the same composition and size, the same diffusion and aging temperature etc. Example 4 shows Br=1.330 T, Hcj=1990 k/m, containing μ phase and δ phase and Comparative example 4 shows Br=1.280 T, Hcj=1751.2 kA/m, only containing δ phase. Br (residual magnetism) and Hcj (coercivity) advantages of the Example is significantly improved compared to the Comparative Example.

Example 5 and Comparative example 5: The NdFeB magnet base alloy are diffused at the same composition and size, the same diffusion and aging temperature etc. Example 5 shows Br=1.325 T, Hcj=1910.4 kA/m, containing μ phase and δ phase and Comparative example 5 shows Br=1.270 T, Hcj=1751.2 kA/m. Br (residual magnetism) and Hcj (coercivity) advantages of the Example is significantly improved compared to the Comparative Example.

Example 6 and Comparative example 6: The NdFeB magnet base alloy are diffused at the same composition and size, the same diffusion and aging temperature etc. Example 6 shows Br=1.335 T, Hcj=1990 k/m, containing μ phase and δ phase and Comparative example 6 shows Br=1.30 T, Hcj=1671.6 kA/m. Br (residual magnetism) and Hcj (coercivity) advantages of the Example is significantly improved compared to the Comparative Example.

Example 7 and Comparative example 7: The NdFeB magnet base alloy are diffused at the same composition and size, the same diffusion and aging temperature etc. Example 7 shows Br=1.347 T, Hcj=1950.2 kA/m, containing μ phase and δ phase and Comparative example 7 shows Br=1.31 T, Hcj=1711.4 kA/m, only containing δ phase. Br (residual magnetism) and Hcj (coercivity) advantages of the Example is significantly improved compared to the Comparative Example. Example 8 and Comparative example 8: The NdFeB magnet base alloy are diffused at the same composition and size, the same diffusion and aging temperature etc. Example 8 shows Br=1.35 T, Hcj=1910.4 kA/m, containing μ phase and δ phase and Comparative example 8 shows Br=1.3 T, Hcj=1631.8 kA/m, only containing δ phase. Br (residual magnetism) and Hcj (coercivity) advantages of the Example is significantly improved compared to the Comparative Example.

Example 9 and Comparative example 9: The NdFeB magnet base alloy are diffused at the same composition and size, the same diffusion and aging temperature etc. Example 9 shows Br=1.29 T, Hcj=2029.8 kA/m, containing μ phase and δ phase and Comparative example 9 shows Br=1.25 T, Hcj=1870.6 kA/m, only containing δ phase. Br (residual magnetism) and Hcj (coercivity) advantages of the Example is significantly improved compared to the Comparative Example.

Example 10 and Comparative example 10: The NdFeB magnet base alloy are diffused at the same composition and size, the same diffusion and aging temperature etc. Example 10 shows Br=1.345 T, Hcj=2029.8 kA/m, containing μ phase and δ phase and Comparative example 10 shows Br=1.3 T, Hcj=1870.6 kA/m, only containing δ phase. Br (residual magnetism) and Hcj (coercivity) advantages of the Example is significantly improved compared to the Comparative Example.

Example 11 and Comparative example 11: The NdFeB magnet base alloy are diffused at the same composition and size, the same diffusion and aging temperature etc. Example 11 shows Br=1.38 T, Hcj=1830.8 kA/m, containing μ phase and δ phase and Comparative example 11 shows Br=1.34 T, Hcj=1671.6 kA/m, only containing δ phase. Br (residual magnetism) and Hcj (coercivity) advantages of the Example is significantly improved compared to the Comparative Example.

Example 12 and Comparative example 12: The NdFeB magnet base alloy are diffused at the same composition and size, the same diffusion and aging temperature etc. Example 12 shows Br=1.37 T, Hcj=1910.40 kA/m, containing μ phase and δ phase and Comparative example 12 shows Br=1.32 T, Hcj=1751.0 kA/m. Br (residual magnetism) and Hcj (coercivity) advantages of the Example is significantly improved compared to the Comparative Example.

Example 13 and Comparative example 13: The NdFeB magnet base alloy are diffused at the same composition and size, the same diffusion and aging temperature etc. Example 13 shows Br=1.23 T, Hcj=1990 kA/m, containing μ phase and δ phase and Comparative example 13 shows Br=1.2 T, Hcj=1830.8 kA/m, only containing δ phase. Br (residual magnetism) and Hcj (coercivity) advantages of the Example is significantly improved compared to the Comparative Example.

Example 14 and Comparative example 14: The NdFeB magnet base alloy are diffused at the same composition and size, the same diffusion and aging temperature etc. Example 14 shows Br=1.25 T, Hcj=1910.4 kA/m, containing μ phase and δ phase and Comparative example 14 shows Br=1.23 T, Hcj=1751.2 kA/m. Br (residual magnetism) and Hcj (coercivity) advantages of the Example is significantly improved compared to the Comparative Example.

Example 15 and Comparative example 15: The NdFeB magnet base alloy are diffused at the same composition and size, the same diffusion and aging temperature etc. Example 15 shows Br=1.335 T, Hcj=1830.8 kA/m, containing μ phase and δ phase and Comparative example 15 shows Br=1.29 T, Hcj=1631.8 kA/m. Br (residual magnetism) and Hcj (coercivity) advantages of the Example is significantly improved compared to the Comparative Example.

Example 16 and Comparative example 16: The NdFeB magnet base alloy are diffused at the same composition and size, the same diffusion and aging temperature etc. Example 16 shows Br=1.325 T, Hcj=2029.8 kA/m, containing μ phase and δ phase and Comparative example 16 shows Br=1.28 T, Hcj=1870.6 kA/m, only containing δ phase. Br (residual magnetism) and Hcj (coercivity) advantages of the Example is significantly improved compared to the Comparative Example.

The foregoing is only a better embodiment of the present disclosure and is not intended to limit the present disclosure, where any modification, equivalent substitution, improvement, etc. made within the spirit and principles of the present disclosure shall be included in the scope of protection of the present disclosure.

TABLE 1
Diffusion sources, process conditions and characteristics of the NdFeB magnet base alloy after diffusion about Examples.

| | | | | | | | 2^{nd} | | Performance after | | | Whether | Whether |
|---|---|---|---|---|---|---|---|---|---|---|---|---|---|
| | | | Diff. | | 1^{st} | | Aging | | Diffusion | | | contains | contains |
| Example | Diffussion | Size | Temp. | time | Aging | time | Temp. | time | | | Hk/ | μ | δ |
| No. | source | mm | ° C. | h | Temp. | h | ° C. | h | Br | Hcj | Hcj | phase | phase |
| 1 | Nd: 70%, Al: 15%, | 10*10*3 | 850 | 15 | 700 | 2 | 450 | 10 | 1.400 | 1711.40 | 0.95 | yes | yes |
| | B: 3%, Fe: Margin | | | | | | | | | | | | |
| 2 | Pr: 65%, Cu: 25%, | 10*10*5 | 800 | 25 | 700 | 3 | 480 | 7 | 1.400 | 1830.80 | 0.94 | yes | yes |
| | B: 2%, Fe: Margin | | | | | | | | | | | | |
| 3 | Nd: 60%, Al: 15%, | 10*10*4 | 850 | 10 | 700 | 5 | 480 | 5 | 1.320 | 1950.20 | 0.94 | yes | yes |
| | Cu: 15%, B: 3%, | | | | | | | | | | | | |
| | Fe: Margin | | | | | | | | | | | | |
| 4 | Pr: 30%, Al: 50%, | 10*10*6 | 900 | 25 | 750 | 8 | 500 | 10 | 1.330 | 1990.00 | 0.95 | yes | yes |
| | Ga: 10%, B: 2%, | | | | | | | | | | | | |
| | Fe: Margin | | | | | | | | | | | | |
| 5 | Pr: 50%, Ga: 15%, | 10*10*4 | 860 | 15 | 750 | 10 | 520 | 3 | 1.325 | 1910.40 | 0.96 | yes | yes |
| | Cu: 30%, B: 1%, | | | | | | | | | | | | |
| | Fe: Margin | | | | | | | | | | | | |
| 6 | Nd: 80%, Cu: 15%, | 10*10*3 | 850 | 10 | 750 | 2 | 600 | 4 | 1.335 | 1990.00 | 0.95 | yes | yes |
| | B: 0.5%, Fe: Margin | | | | | | | | | | | | |
| 7 | Pr: 80%, Ga: 15%, | 10*10*4 | 880 | 10 | 750 | 3 | 540 | 3 | 1.347 | 1950.20 | 0.94 | yes | yes |
| | B: 0.1%, Fe: Margin | | | | | | | | | | | | |
| 8 | Pr: 70%, Ga: 10%, | 10*10*3 | 900 | 10 | 750 | 5 | 500 | 8 | 1.350 | 1910.40 | 0.95 | yes | yes |
| | Cu: 15%, B: 0.8%, | | | | | | | | | | | | |
| | Fe: Margin | | | | | | | | | | | | |
| 9 | Pr: 50%, Cu: 40%, | 10*10*5 | 900 | 15 | 800 | 8 | 490 | 6 | 1.290 | 2029.80 | 0.94 | yes | yes |
| | B: 2%, Fe: Margin | | | | | | | | | | | | |
| 10 | Pr: 60%, Al: 20%, | 10*10*5 | 910 | 15 | 800 | 10 | 450 | 5 | 1.345 | 2029.80 | 0.95 | yes | yes |
| | Cu: 15%, B: 0.5%, | | | | | | | | | | | | |
| | Fe: Margin | | | | | | | | | | | | |
| 11 | Pr: 65%, Al: 15%, | 10*10*7 | 900 | 30 | 800 | 2 | 500 | 10 | 1.380 | 1830.80 | 0.95 | yes | yes |
| | Cu: 15%, B: 1%, | | | | | | | | | | | | |
| | Fe: Margin | | | | | | | | | | | | |
| 12 | Nd: 30%, Pr: 40%, | 10*10*8 | 910 | 30 | 800 | 3 | 480 | 8 | 1.370 | 1910.40 | 0.95 | yes | yes |
| | Cu: 20%, B: 1%, | | | | | | | | | | | | |
| | Fe: Margin | | | | | | | | | | | | |
| 13 | Nd: 50%, Cu: 20%, | 10*10*4 | 900 | 15 | 850 | 5 | 450 | 8 | 1.230 | 1990.00 | 0.95 | yes | yes |
| | Al: 20%, B: 2%, | | | | | | | | | | | | |
| | Fe: Margin | | | | | | | | | | | | |
| 14 | Nd: 45%, Cu: 30%, | 10*10*5 | 900 | 7 | 850 | 8 | 500 | 6 | 1.250 | 1910.40 | 0.94 | yes | yes |
| | Al: 10%, B: 1%, | | | | | | | | | | | | |
| | Fe: Margin | | | | | | | | | | | | |
| 15 | Nd: 60%, Cu: 15%, | 10*10*4 | 900 | 8 | 850 | 10 | 530 | 4 | 1.335 | 1830.80 | 0.95 | yes | yes |
| | Ga: 15%, B: 4%, | | | | | | | | | | | | |
| | Fe: Margin | | | | | | | | | | | | |
| 16 | Pr: 70%, Cu: 10%, | 10*10*6 | 910 | 20 | 850 | 3 | 470 | 10 | 1.325 | 2029.80 | 0.94 | yes | yes |
| | Al: 15%, B: 0.5%, | | | | | | | | | | | | |
| | Fe: Margin | | | | | | | | | | | | |

TABLE 2
Composition of NdFeB base alloy and its performance

| | Composition of NdFeB base alloy wt % | | | | | | | | | | Performance | | |
|---|---|---|---|---|---|---|---|---|---|---|---|---|---|
| | R | | M | | | | | | | | Br | Hcj | Hk/ |
| Number | Pr | Nd | Cu | AI | Ga | Co | Ti | Zr | Fe | B | T | kA/m | Hcj |
| 1 | 8.58 | 21.71 | 0.16 | 0.17 | 0.27 | 0.85 | 0.02 | 0.00 | Margin | 0.90 | 1.430 | 1384.24 | 0.99 |
| 2 | 3.99 | 26.55 | 0.13 | 0.14 | 0.32 | 0.46 | 0.02 | 0.07 | Margin | 0.88 | 1.430 | 1424.84 | 0.99 |
| 3 | 4.08 | 26.55 | 0.16 | 0.19 | 0.26 | 0.81 | 0.12 | 0.00 | Margin | 0.89 | 1.358 | 1592.80 | 0.98 |
| 4 | 7.60 | 23.62 | 0.38 | 0.28 | 0.37 | 0.76 | 0.09 | 0.00 | Margin | 0.87 | 1.360 | 1604.74 | 0.99 |
| 5 | 6.09 | 25.44 | 0.14 | 0.34 | 0.52 | 0.93 | 0.18 | 0.00 | Margin | 0.91 | 1.355 | 1576.08 | 0.98 |
| 6 | 6.98 | 24.00 | 0.19 | 0.33 | 0.42 | 0.86 | 0.10 | 0.00 | Margin | 0.90 | 1.366 | 1502.05 | 0.99 |
| 7 | 6.70 | 24.10 | 0.23 | 0.25 | 0.28 | 0.94 | 0.07 | 0.00 | Margin | 0.87 | 1.376 | 1472.60 | 0.98 |
| 8 | 7.45 | 24.03 | 0.23 | 0.34 | 0.29 | 0.91 | 0.08 | 0.00 | Margin | 0.89 | 1.380 | 1488.52 | 0.99 |
| 9 | 4.50 | 26.55 | 0.16 | 0.50 | 0.39 | 0.81 | 0.04 | 0.09 | Margin | 0.89 | 1.320 | 1671.60 | 0.98 |
| 10 | 8.34 | 22.87 | 0.16 | 0.35 | 0.44 | 1.58 | 0.08 | 0.00 | Margin | 0.87 | 1.365 | 1576.08 | 0.99 |
| 11 | 8.84 | 21.47 | 0.21 | 0.20 | 0.30 | 1.45 | 0.04 | 0.00 | Margin | 0.90 | 1.420 | 1393.00 | 0.98 |
| 12 | 6.56 | 23.48 | 0.14 | 0.20 | 0.37 | 0.43 | 0.06 | 0.00 | Margin | 0.90 | 1.398 | 1498.07 | 0.99 |
| 13 | 0.00 | 32.80 | 0.25 | 0.95 | 0.20 | 1.50 | 0.00 | 0.00 | Margin | 1.10 | 1.260 | 1393.00 | 0.99 |
| 14 | 0.00 | 32.80 | 0.15 | 0.95 | 0.20 | 1.50 | 0.00 | 0.00 | Margin | 1.00 | 1.270 | 1353.20 | 0.99 |
| 15 | 6.30 | 25.20 | 0.15 | 0.60 | 0.20 | 0.50 | 0.10 | 0.00 | Margin | 0.91 | 1.360 | 1353.20 | 0.98 |
| 16 | 8.21 | 23.60 | 0.16 | 0.35 | 0.35 | 0.74 | 0.15 | 0.00 | Margin | 0.86 | 1.342 | 1694.68 | 0.99 |

TABLE 3
Diffusion sources, process conditions and characteristics of the NdFeB
magnet base alloy after diffusion about Comparative Examples.

| | | | | | | | Performance after | | | Whether | Whether |
|---|---|---|---|---|---|---|---|---|---|---|---|
| Comparative | | | Diffusion | Holding | Aging | Holding | Diffusion | | | contains | contains |
| Example | Diffussion | Size | Temp. | time | Temp. | time | Br | Hcj | Hk/ | μ | δ |
| No. | source | mm | ° C. | h | ° C. | h | T | kA/m | Hcj | phase | phase |
| 1 | Nd: 85%, Al: 15% | 10*10*3 | 850 | 15 | 450 | 10 | 1.360 | 1592.00 | 0.95 | No | yes |
| 2 | Pr: 75%, Cu: 25% | 10*10*5 | 800 | 25 | 480 | 7 | 1.3 | 1671.60 | 0.95 | No | yes |
| 3 | Nd: 70%, Al: 15%, | 10*10*4 | 850 | 10 | 480 | 5 | 1.290 | 1791.00 | 0.94 | No | yes |
| | Cu: 15% | | | | | | | | | | |
| 4 | Pr: 40%, Al: 50%, | 10*10*6 | 900 | 25 | 500 | 10 | 1.280 | 1751.20 | 0.95 | No | yes |
| | Ga: 10% | | | | | | | | | | |
| 5 | Pr: 55%, Ga: 15%, | 10*10*4 | 860 | 15 | 520 | 3 | 1.270 | 1751.20 | 0.95 | No | No |
| | Cu: 30% | | | | | | | | | | |
| 6 | Nd: 85%, Cu: 15% | 10*10*3 | 850 | 10 | 600 | 4 | 1.300 | 1671.60 | 0.96 | No | No |
| 7 | Pr: 85%, Ga: 15% | 10*10*4 | 880 | 10 | 540 | 3 | 1.310 | 1711.40 | 0.94 | No | yes |
| 8 | Pr: 75%, Ga: 10%, | 10*10*3 | 900 | 10 | 500 | 8 | 1.300 | 1631.80 | 0.96 | No | yes |
| | Cu: 15% | | | | | | | | | | |
| 9 | Pr: 60%, Cu: 40% | 10*10*5 | 900 | 15 | 490 | 6 | 1.250 | 1870.60 | 0.94 | No | yes |
| 10 | Pr: 65%, Al: 20%, | 10*10*5 | 910 | 15 | 450 | 5 | 1.300 | 1870.60 | 0.94 | No | yes |
| | Cu: 15% | | | | | | | | | | |
| 11 | Pr: 70%, Al: 15%, | 10*10*7 | 900 | 30 | 500 | 10 | 1.340 | 1671.60 | 0.95 | No | yes |
| | Cu: 15% | | | | | | | | | | |
| 12 | Nd: 40%, Pr: 40%, | 10*10*8 | 910 | 30 | 480 | 8 | 1.320 | 1751.20 | 0.94 | No | No |
| | Cu: 20% | | | | | | | | | | |
| 13 | Nd: 60%, Cu: 20%, | 10*10*4 | 850 | 15 | 450 | 8 | 1.200 | 1830.80 | 0.95 | No | yes |
| | Al: 20% | | | | | | | | | | |
| 14 | Nd: 60%, Cu: 30%, | 10*10*5 | 900 | 7 | 500 | 6 | 1.230 | 1751.20 | 0.94 | No | No |
| | Al: 10% | | | | | | | | | | |
| 15 | Nd: 70%, Cu: 15%, | 10*10*4 | 850 | 8 | 530 | 4 | 1.290 | 1631.80 | 0.95 | No | No |
| | Ga: 15% | | | | | | | | | | |
| 16 | Pr: 75%, Cu: 10%, | 10*10*6 | 910 | 20 | 470 | 10 | 1.280 | 1870.60 | 0.94 | No | yes |
| | Al: 15% | | | | | | | | | | |

What claimed is:

1. A rare earth magnet, wherein the rare earth magnet is a NdFeB magnet, and the NdFeB magnet comprises a main phase, a grain boundary phase and a rare earth-rich phase, wherein the grain boundary phase comprises a μ phase and a δ phase, the μ phase is R_{36.5}Fe_{63.5-x}Mₓ, 1≤x≤4; the δ phase is R_{32.5}Fe_{67.5-y}M_{y}, 2≤y≤20, wherein R refers to at least two elements selected from Nd, Pr, Ce and La, and M refers to at least two elements selected from Al, Cu and Ga; wherein the proportions are given in atomic percentages.

2. A method for preparing a rare earth magnet according to claim 1, wherein it comprises the following steps,
(S1) the preparation of a diffusion source: providing a diffusion source alloy of chemical formula RₐM_{β}B_{γ}Fe_{100-α-β-γ}, wherein 10≤α≤80, 15≤β≤90, 0.1≤γ≤3, R is at least one of Nd and Pr, and M is at least one of Al, Cu and Ga; the diffusion source alloy is treated by aging to form the diffusion source, then is treated by hydrogen absorption and dehydrogenation; wherein the proportions are given in mass percentage;
(S2) the preparation of NdFeB base material: preparing main alloy and auxiliary alloy of NdFeB magnet base material, the chemical formula of the mixed alloy of the main alloy and the auxiliary alloy is R_{α}M_{b}B_{c}Fe_{100-a-b-c}, wherein 27≤a≤33, 1≤b≤4, 0.8≤c≤1.2, R refers to one or more of Nd, Pr, Ce and La, and M refers to one or more of Al, Cu, Ga, Ti, Zr, Co, Mg, Zn, Nb, Mo and Sn, the remaining component is Fe; wherein the proportions are given in mass percentage;
(S3) a diffusion source film layer is coated on the NdFeB base material, which is diffused and aged to obtain NdFeB magnet.

3. The method for preparing a rare earth magnet according to claim 2, wherein in step (S2), the NdFeB base material flakes are mixed with lubricants under hydrogen treatment, and grounded by airflow grinding to prepare mixed powders; then, the mixed powders are pressed, formed and sintered to obtain the NdFeB magnet base material.

4. The method for preparing a rare earth magnet according to claim 2, wherein in step (S1), the diffusion source is powder form and the preparation method of the diffusion source is atomized comminuting process, amorphous throwing belt milling process or ingot milling process.

5. The method for preparing a rare earth magnet according to claim 2, wherein in step (S1), the hydrogen absorption temperature is 50-200° C., and the dehydrogenation temperature is 450-550° C.

6. The method for preparing a rare earth magnet according to claim 3, wherein powder particle size of the airflow grinding is 2-5 μm.

7. The method for preparing a rare earth magnet according to claim 4, wherein powder particle size of the diffusion source is 3-60 μm.

8. The method for preparing a rare earth magnet according to claim 2, wherein in step (S3) the method of coating is one of magnetron sputtering coating, evaporation coating and silk screening coating.

9. The method for preparing a rare earth magnet according to claim 3, wherein the temperature of sintering process for preparing the NdFeB magnet base material is 980-1060° C., sintering time is 6-15 h.

10. The method for preparing a rare earth magnet according to claim 2, wherein in step (S3), diffusion temperature is 800-910° C., diffusion time is 6-30 h, and first-stage aging temperature is 700-850° C., first-level aging time is 2-10 h, second-level aging temperature is 450-600° C., and second-level aging time is 3-10 h.

11. A rare earth magnet prepared by the method according to claim 2.

12. The rare earth magnet according to claim 11, wherein the rare earth magnet is a NdFeB magnet, and the NdFeB magnet comprises a main phase, a grain boundary phase and a rare earth-rich phase, wherein the grain boundary phase comprises a μ phase and a δ phase, the μ phase is R_{36.5}Fe_{63.5}Mₓ, 1≤x≤4; the 6 phase is R_{32.5}Fe_{67.5-y}M_{y}, 2≤y≤20, wherein R refers to at least two elements selected from Nd, Pr, Ce and La, and M refers to at least two elements selected from Al, Cu and Ga; wherein the proportions are given in atomic percentages.
